(19) United States
(12) Patent Application Publication
(10) Pub. No.: US 2009/0259432 A1
(43) Pub. Date: Oct. 15, 2009

(54) TRACKING DETERMINATION BASED ON INTENSITY ANGULAR GRADIENT OF A WAVE

(76) Inventors: Matthew G. Liberty, Gaithersburg, MD (US); Joseph S. Tanen, Gaithersburg, MD (US)

Correspondence Address: POTOMAC PATENT GROUP PLLC, P. O. BOX 270, FREDERICKSBURG, VA, 22404, US

(21) Appl. No.: 12/424,090

(22) Filed: Apr. 15, 2009

Related U.S. Application Data
(60) Provisional application No. 61/045,038, filed on Apr. 15, 2008.

(51) Int. Cl. G06F 15/00

(52) U.S. Cl. 702/150

(57) ABSTRACT

Handheld device, base station, computer readable medium and method for detecting a position of a handheld device. The method includes measuring intensities of at least one beam emitted by a base station; calculating relative intensities based on the measured intensities; and determining the position of the handheld device based on the measured intensities and the calculated relative intensities.

### RELATED APPLICATIONS

This application is related to, and claims priority from, U.S. Provisional Patent Application Ser. No. 61/045,038 filed on Apr. 15, 2008, entitled “Tracking Determination Based on Relative Intensity Angular Gradient of Electromagnetic Wave,” the disclosure of which is incorporated entirely here by reference.

### TECHNICAL FIELD

The present invention generally relates to tracking a linear position and an angular position of a device relative to a base station and, more particularly, to methods and techniques for tracking the linear position and the angular position based on an angular gradient distribution of an intensity of an electromagnetic wave generated by an electromagnetic source.

### BACKGROUND

During the past years, the interest of having a handheld device, for example, a wand, pen, gaming device, remote control, mouse, etc., free of any wired link to a device, i.e., computer, TV set, game console, or other devices has increased. The users prefer to use a handheld device that may be moved freely in space in order to control and/or interact with a desired device. While various technologies allow such a handheld device, determining the accurate linear position and angular position (orientation) of the handheld device relative to a base station or the device continues to be a problem. These technologies use various rotational sensors and accelerometers to track the linear position of the handheld device and also to estimate an angular position of the handheld device, but the handheld motions are tracked relative to the handheld device itself. Examples of these technologies are disclosed in application Ser. No. 11/820,517, filed on Jun. 20, 2007, application Ser. No. 11/640,677, filed Dec. 18, 2006 and which issued on Aug. 28, 2007 as U.S. Pat. No. 7,262,760, application Ser. No. 11/119,719, filed May 2, 2005 and which issued on Jan. 2, 2007 as U.S. Pat. No. 7,158,118, in which, for example, various structures having one 3-D Accelerometer and one 2-D angular rate sensor, or two 3-D Accelerometers and one 3-D magnetometer, or one 3-D Accelerometer and one 3-D angular rate sensor, are disclosed.

Other technologies (see for example U.S. Pat. Nos. 7,188,045 and 7,353,134, the content of which are incorporated herein by reference) that permit tracking with respect to a fixed point or base station, are cumbersome, require multiple sensors installed in a given room where the handheld device is to be used, use wired links between these sensors and the base unit, and are unstable and significantly affected by minute changes in radiation intensity.

Accordingly, it would be desirable to provide devices, systems and methods for tracking a linear position and angular position (orientation) of a handheld device that avoid the afore-described problems and drawbacks.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a diagram of a system including a base station and a handheld device according to an exemplary embodiment;

FIG. 2 illustrates a frame of reference of the handheld device relative to a frame of reference of the base station according to an exemplary embodiment;

FIG. 3 illustrates a structure of the handheld device and the base station according to an exemplary embodiment;

FIG. 4 illustrates the coordinates used to describe a point in space relative to an emitter or receiver according to an exemplary embodiment;

FIG. 5 illustrates a beam intensity emitted by an emitter according to an exemplary embodiment;

FIG. 6 is a diagram of a structure of an array of emitters or receivers according to an exemplary embodiment;

FIG. 7 illustrates the intensity of a single emitter measured by two receivers closely located in space but angularly separated;

FIG. 8A is a diagram of the intensity measured over receiver angle of a single emitter measured by two receivers closely located in space but angularly separated;

FIG. 8B is a diagram showing relative intensities corresponding to the intensities shown by FIG. 8A;

FIG. 9 is a flow diagram illustrating steps of operation of the handheld device according to an exemplary embodiment;

FIG. 10 is a flow diagram illustrating steps for calculating a position of the handheld device according to an exemplary embodiment; and

FIG. 11 is a diagram illustrating various software modules of a processor configured to calculate the position of the handheld device according to an exemplary embodiment.

### SUMMARY OF THE INVENTION

According to an exemplary embodiment, there is a method for detecting a position of a handheld device. The method includes measuring intensities of at least one beam emitted by a base station; calculating relative intensities based on the measured intensities; and determining the position of the handheld device based on the measured intensities and the calculated relative intensities.

According to another exemplary embodiment, there is a handheld device for detecting a position relative to a base station with which the handheld device communicates. The handheld device includes a first receiver configured to measure intensities of beams emitted by a base station and a processor connected to the first receiver. The processor is configured to calculate relative intensities based on the measured intensities, and determine the position of the handheld device based on the measured intensities and the calculated relative intensities.

According to still another exemplary embodiment, there is a base station configured to communicate with a handheld device. The base station includes at least one emitter configured to emit a beam including an electromagnetic wave such that an intensity of the beam has a desired angular distribution in space and a processor configured to control an emitting time of the at least one emitter. The amplitude of the beam follows a same pattern in time at a given location.

According to another exemplary embodiment, there is a system that includes a handheld device having a first receiver; a base station having plural emitters and configured to communicate with the handheld device; and a processor connected to the first receiver. The first receiver is configured to measure intensities of beams emitted by the emitters, the processor is configured to calculate relative intensities based on the measured intensities, and the processor is configured to determine the position of the handheld device based on the measured intensities and the calculated relative intensities.

According to another exemplary embodiment, there is a computer readable medium including computer executable instructions, wherein the instructions, when executed, implement a method for detecting a position of a handheld device. The method includes providing a system comprising distinct software modules, wherein the distinct software modules comprise a relative intensity calculation module, a linear position calculation module and an angular position calculation module; measuring intensities of at least one beam emitted by a base station; calculating, based on the relative intensity calculation module, relative intensities based on the measured intensities; and determining, based on the linear position calculation module, the position of the handheld device based on the measured intensities and the calculated relative intensities.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of infrared capable devices, i.e., infrared emitters and receivers. However, the embodiments to be discussed next are not limited to these systems but may be applied to other systems that use other forms of electromagnetic waves or non-electromagnetic waves such as acoustic waves.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

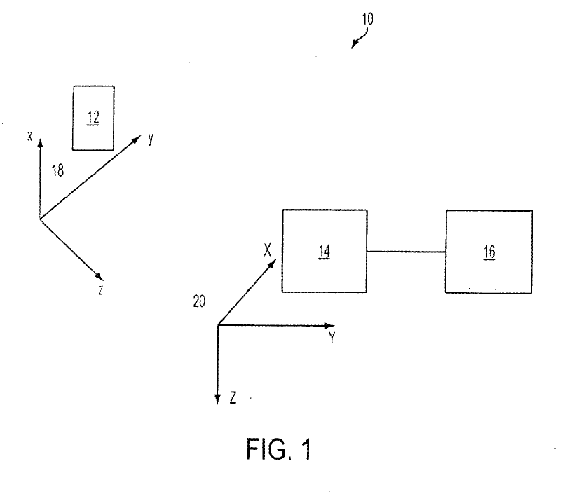

As shown in FIG. 1, according to an exemplary embodiment, a system 10 includes a handheld device 12 and a base station 14. The base station 14 may be linked, for example, to a computing device 16. The link between the base station 14 and the computing device 16 may be wired or wireless. The handheld device 12 is free of any wired link to the base station 14 and/or computing device 16. According to an exemplary embodiment, the base station 14 may be part of the computing device 16.

The handheld device 12 has a first system of reference xyz 18 and the base station 14 has a second system of reference XYZ 20. The second system of reference XYZ 20 may or may not be identical to the reference system of Earth. In one exemplary embodiment, the system of reference 20 is fixed, i.e., cannot move or rotate while the system of reference 18 is free to rotate and move relative to the system of reference 20, i.e., it may be fixed to the handheld device 12. In another exemplary embodiment, the system of reference 18 may have any angular position relative to the handheld device 12, but once a certain angular position is selected, that angular position is maintained constant. Thus, supposing that the system of reference 18 is fixed to the handheld device 12, some of the following exemplary embodiments disclose how the position of system of reference 18 is determined relative to the system of reference 20 as the handheld device 12 moves.

The term position may refer to linear position, angular position, or a combination of both linear position and angular position. Pose is another common synonymous industry term for position. Linear position refers to the location which is defined by any number of methods including a 3D vector of Cartesian coordinates, a 3D vector of spherical coordinates, etc. Angular position refers to the 3D orientation which is defined by any number of methods including Euler angles, direction cosine matrix, quaternion, vector/angle, Pauli spin matrix, direction+normal vector, etc.

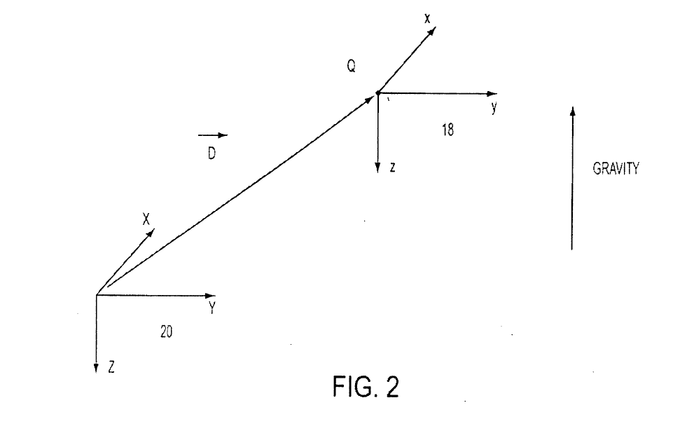

FIG. 2 shows a generic illustration of the problem that, the handheld device, the base station or both of them has to solve. In this respect, it is noted that the entire calculations for solving the problem or part of them may be performed in the handheld device, the base station, the device to which the base station is connected to or by a combination of these devices. According to exemplary embodiments discussed next, the calculations for determining the position of the handheld device are performed in the handheld device itself. FIG. 2 shows the fixed system of reference 20 and the free movable system of reference 18. A displacement from the zero of the system of reference 20 to the zero of the system of reference 18 is D and indicates the linear position of the system of reference 18 (and implicit the linear position of the handheld device 12) relative to the system of reference 20 (and implicit relative to the base station 14). It is noted that D is a vector and not a scalar quantity, i.e., D indicates not only the distance between the system of references 18 and 20 but also the 3D linear position of the zero of the system of reference 18 relative to the system of reference 20. D can be defined using any coordinate method, including Cartesian coordinates and spherical coordinates.

However, knowing the linear position of the system of reference 18 relative to the system of reference 20 does not provide an indication regarding the angular position of the system of reference 18 (i.e., the handheld device 12) relative to the system of reference 20 (i.e., the base station 14). Thus, more information is necessary for estimating the angular position of the handheld device. This supplementary information is quantified as Q_{R} and provides the angular position of the system of reference 18 relative to the system of reference 20. For example, the data included in Q_{R} may be Euler angles, direction cosine matrix, quaternion, vector/angle, Pauli spin matrix, direction+normal vector, etc.

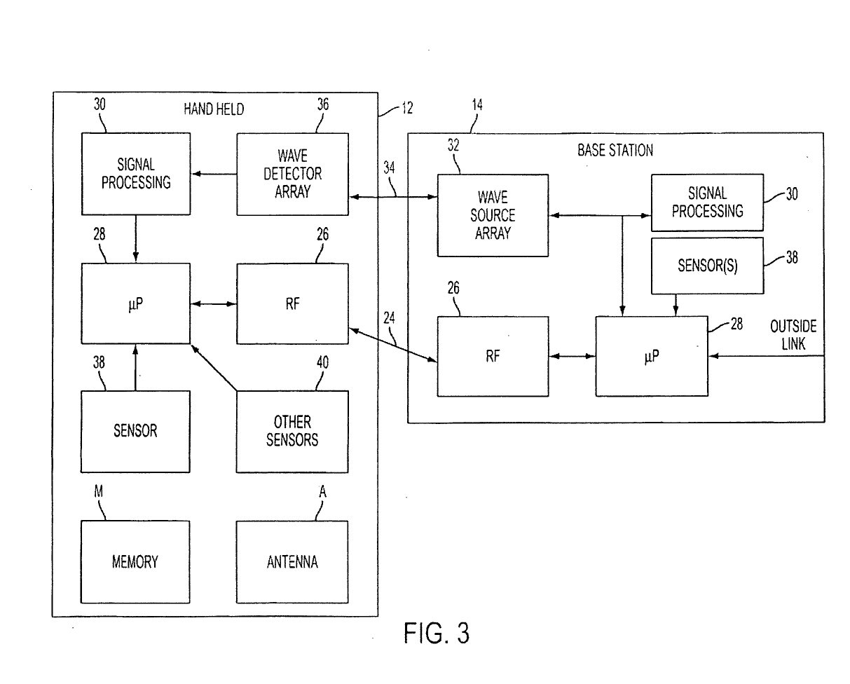

To determine the above discussed D and Q_{R} information, FIG. 3 shows, according to an exemplary embodiment, a structure of the handheld device 12 and the base station 14. However, other structures are also possible as long as both D and Q_{R} may be determined by these structures. FIG. 3 shows the handheld device 12 and the base station 14 communicating via a wireless interface 24. The wireless interface 24 is a radio frequency RF interface in this exemplary embodiment but may be other wireless interfaces as would be recognized by those skilled in the art. Each of the handheld device 12 and the base station 14 has a corresponding RF unit 26 for performing the wireless communication. Although the same reference number 26 is used for the RF units, these RF units may be different in structure or characteristics. The same is true for further components of the handheld device and the base station that are labeled with the same reference number.

Each of the handheld device 12 and the base station 14 may include a corresponding microprocessor 28, which may coordinate the communications between the handheld device and the base station and also determine the information needed for determining the position of the handheld device. The microprocessors 28 are connected to the RF units 26. Further, each of the handheld device and the base station may include a signal processing section 30, which may include analog processing, digital processing, analog to digital units, amplifiers, filters and other components that are used in the signaling processing art for analyzing analog and/or digital signals. The signal processing sections 30 are connected to the processors 28.

The base station 14 may include a wave source array 32, which in this exemplary embodiment, includes at least three infrared sources. One example of an infrared source is an infrared light emitting diode (LED) that produces infrared radiation 34. Other sources of electromagnetic waves or acoustic waves may be used. The wave source array 32 is configured to emit three different infrared beams, one beam for each LED device. Correspondingly, the handheld device 12 includes, in this exemplary embodiment, an infrared wave detector array 36 that is configured to detect the infrared waves 34. One example of an infrared detector 36 is an infrared photodiode. The infrared wave detector array 36 may include at least three different receivers.

The use of infrared beams for communication between the handheld device 12 and the base station 14 has advantages and disadvantages. One advantage is the fact that infrared radiation is easily and rapidly stopped by a wall and other structures. Thus, interference between the infrared radiation used in the room where the handheld device is used and infrared radiation from other devices in other rooms is minimized. However, the handheld device 12 and the base station 14 need to be in each other's line of sight in order to have infrared based communications.

In an exemplary embodiment, the wave source array 32 of the base station 14 includes a wave detector unit 36 and vice versa, such that each of the handheld device 12 and the base station 14 may emit and receive the infrared waves. Alternatively, the source array 32 may be configured to also work as a detector and the detector array 36 may be configured to also work as a source. However, for simplicity, the next exemplary embodiments assume that the base station 14 is the source of the infrared waves and the handheld device 12 detects the infrared waves.

The handheld device 12 may include additional sensors 38, which in this exemplary embodiment, is a 3-axis accelerometer. An output of this sensor 38 is used in conjunction with the output from the wave detector 36 to unequivocally determine the D and Q_{R}. However, the sensor 38 may be included in the base station 14 such that the base station may function as the detector and the handheld device may function as the source of the infrared radiation. Optionally, the handheld device may include other sensors 40, which might be used to improve the accuracy of the determination of D and Q_{R}, as for example, rotational sensors. Further, the base station 14 may include circuitry to drive each infrared LED. Base station 14 may also include USB port, SPI bus, UART, or I2C bus to connect to a host. The handheld device 12 may include a memory M, an antenna A, analog processing to measure the intensity of each infrared LED for each infrared photodiode, analog to digital circuitry to convert nine infrared intensities and three accelerometer values to digital, battery and associated power conditioning, buttons, scroll wheels, and other accessories as applicable.

The system needs to distinguish the intensity for each emitter as measured by each receiver. There are various possibilities for discriminating at a receiver between infrared intensities generated by different emitters. One such possibility is that each infrared emitter may transmit at a different modulation frequency. The infrared receiver then independently filters each channel before determining the corresponding intensity. Another possibility is to have the infrared emitters run at the same modulation frequency with time division multiplexing (TDM). Time division multiplexing may significantly simplify the analog design complexity at both the emitter and receiver. The existing Freespace® solution from the assignee of this application already accurately synchronizes timing between the base station and the handheld over RF adding little complexity to the TDM solution. The handheld can also synchronize to the base station using a known emitter sequence. One skilled in the art will recognize that the method above is a simple frequency division multiplexing (FDM) scheme. More advanced digital modulation schemes could also be used to further simplify analog design and potentially improve robustness. Another possibility is that each infrared emitter may transmit at a different carrier frequency. The infrared receiver then independently filters each channel by carrier frequency before determining the corresponding intensity.

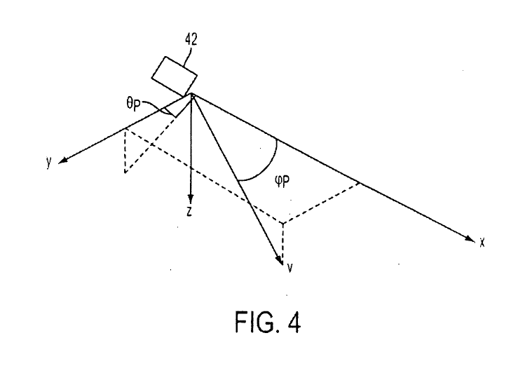

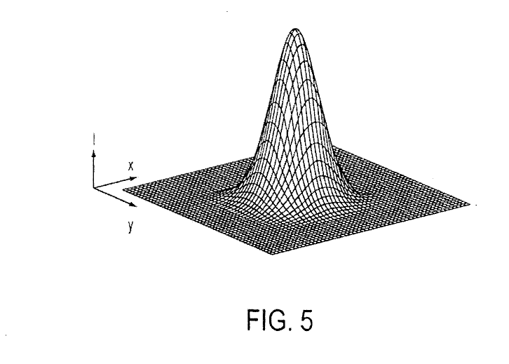

Having described one possible structure of the handheld device 12 and the base station 14, the determination of D and Q_{R} is discussed next. An example of an infrared emitter or receiver 42 is shown in FIG. 4. The emitter 42 may be part of the wave source array 32 and/or the wave detector array 36. The emitter 42 is assumed to emit an infrared wave that has a set angular gradient intensity distribution. For example, a set angular gradient intensity distribution is shown in FIG. 5, which is a normal (Gaussian) distribution.

A vector v is used to indicate a point in space relative to the emitter 42. For example, vector v may indicate the position of the base station 14. Vector v may be expressed in spherical coordinates, having thus a length v, angle φ_{P} and angle θ_{P}. The vector v is at an angle φ_{P} from the X-axis and the projection of vector v onto the YZ plane is at an angle θ_{P} from the Y-axis. The angle θ_{P} could alternatively be defined relative to the -Y-axis, Z-axis, -Z-axis, or any vector in the YZ-plane. For simplicity, these angles may be bounded to a domain such as 0°≦φ_{P}≦180° and −180°<θ_{P}≦180°. Other such bounding domains are the forward hemisphere such as 0°≦φ_{P}≦90° and −180°<θ_{P}≦180°, and −90°≦φ_{P}≦90° and 0°≦θ_{P}<180°. The infrared emitters and receivers may have the following characteristics: each has a known radiation pattern, which may the same for all sensors or different; for φ_{P}=constant, an equivalent radiation intensity is expected for all θ_{P}, i.e., measuring the intensity for different θ_{P} but the same φ_{P}, a same intensity is measured; the radiation intensity monotonically decreases from φ_{P}=0 to φ_{P}=90°; and sufficient intensity and width for the application's range and spatial variation are available. For the normal distribution, width corresponds to standard deviation.

According to one exemplary embodiment, the angular gradient intensity distribution of the infrared emitter 42 is as shown in FIG. 5, i.e., a Gaussian distribution. Other distributions are also possible. According to an exemplary embodiment, a beam having a predefined intensity distribution may be used as long as its angular intensity distribution has a non-zero gradient in at least a point. In one application, each emitter may have a different angular distribution of the intensity. FIG. 5 shows the values of the infrared intensity for points in space having a same X value. A similar figure would be generated for constant distance as a function of φ_{P} and θ_{P}. The Y and Z axes indicate the y and z coordinates of the point where the intensity is measured and the X value indicates the value of the intensity of the infrared distribution at that point.

According to an exemplary embodiment, the angular gradient intensity distribution of the infrared emitter 42e may be determined using a calibration process. A receiver with a known radiation pattern may be used to measure the infrared intensity as a function of distance, φ_{P} and θ_{P}. The received infrared intensity may be stored as a means to characterize the angular gradient intensity of the infrared emitter. This process may be repeated for any positive, nonzero number of locations. To simplify the calibration process, the calibration could be performed over a number of locations at the same distance or over a number of locations in the same plane. The data from multiple locations can be collected using a single receiver or an array of receivers.

According to an exemplary embodiment, the angular gradient intensity distribution of infrared receiver 42r may be determined using a calibration process. An emitter with a known radiation pattern may be used to provide infrared intensity as a function of distance, φ_{P} and θ_{P}. The received infrared intensity may be stored as a means to characterize the angular gradient intensity of the infrared receiver. This process may be repeated for any positive, nonzero number of locations. To simplify the calibration process, the calibration could be performed over a number of locations at the same distance or over a number of locations in the same plane. The data from multiple locations can be collected using a single emitter or an array of emitters.

Next, according to an exemplary embodiment, an example for calculating the position of a handheld device is discussed. For simplicity, a two receiver and one emitter system is discussed in this exemplary embodiment. Given an infrared emitter, a function “f_{E}” that relates φ_{E1} shown in FIG. 4, θ_{E1} shown in FIG. 4 and a function “g_{E1}” that relates a distance “d” to the intensity “i_{E1}” of an idealized, omnidirectional receiver may be used to express the intensity “i_{E1}” as:

i_{E1}=f_{E}(φ_{E1},θ_{E1})g_{E1}(d),

where g_{E1}(d) is proportional to 1/d² and “i_{E1}” is a scalar value that corresponds to the observed intensity of the single emitter. Based on this relation and assuming that θ_{E1} does not affect the output, an angle φ_{E1} is given by:

φ_{E1}=f_{E}⁻¹(i_{E1}/g_{E1}(d)).

Likewise, these equations apply to the intensity measured by a receiver from an idealized, omnidirectional source:

i_{R1}=f_{R}(φ_{R1},θ_{R1})g_{E1}(d)

φ_{R1}=f_{R}⁻¹(i_{R1}/g_{E1}(d)).

The equation for the actual measured intensity produced by a non-ideal emitter and received by a non-ideal receiver is:

i_{E1R1}=f_{R}(φ_{R1},θ_{R1})f_{E}(φ_{E1},θ_{E1})g_{E1}(d).

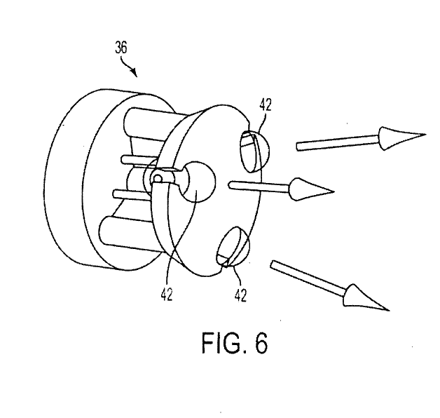

To generate a gradient distribution of the infrared intensity, the emitters may be geometrically dispersed. For example, the emitters may be arranged into a spherical equilateral triangle with the emitters angularly spaced. In one exemplary embodiment shown in FIG. 6, each emitter is collocated but angularly spaced by 15° from the other emitters. The same configuration may be used for the receivers 42. Because of the angular gradient intensity distribution, two collocated receivers pointing in different directions may detect large intensity differences for the same emitter. Likewise, a single receiver may detect large intensity differences for two collocated emitters pointing in different directions. The notion of relative intensity is introduced next for describing the intensity differences noted above and also for calculating various angles.

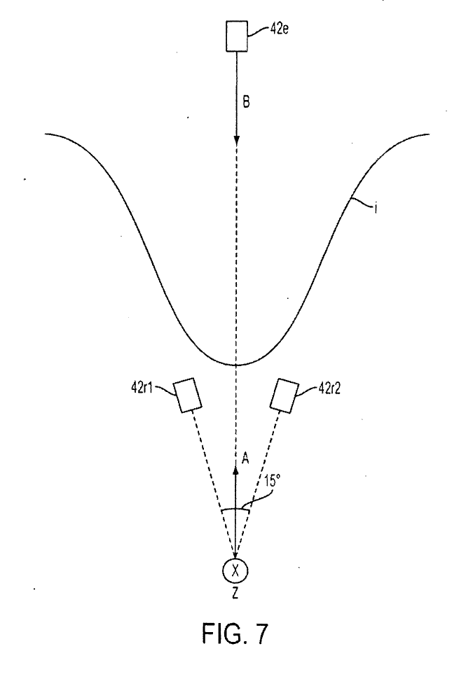

The relative intensity values can be used to determine an angle independent of the absolute intensity value while not requiring spatial diversity of the sensors. To illustrate how the relative intensities are used for calculating the angles, FIG. 7 shows a single emitter 42e that produces a beam having a normal distribution intensity over φ_{P} with zero mean and a standard deviation of σ=30°, and the beam does not vary as a function of θ_{P}. Two receivers 42r1 and 42r2 are spaced 15° apart and the receivers 42r1 and 42r2 measure the intensities i_{E1R1} and i_{E1R2}. A longitudinal axis of the two receivers 42r1 and 42r2 is A and a longitudinal axis of the single emitter 42e is B. FIG. 7 shows the two axes A and B aligned. However, an angle different from zero may exist between axes A and B. The receivers 42r1 and 42r2 are rotated together by a same angle about an axis Z (which is a vector determined by the cross product of the forward direction for each receiver 42r1 and 42r2) as shown in FIG. 7. The distance between Z and 42r1 and the distance between Z and 42r2 are illustrative only. In the exemplary embodiment, 42r1 and 42r2 are collocated and these distances are zero. The intensity measurements illustrated by FIG. 7 may be performed, for example in a laboratory, prior to configuring the handheld device 12 and/or base station 14 to determine the position of the handheld device 12.

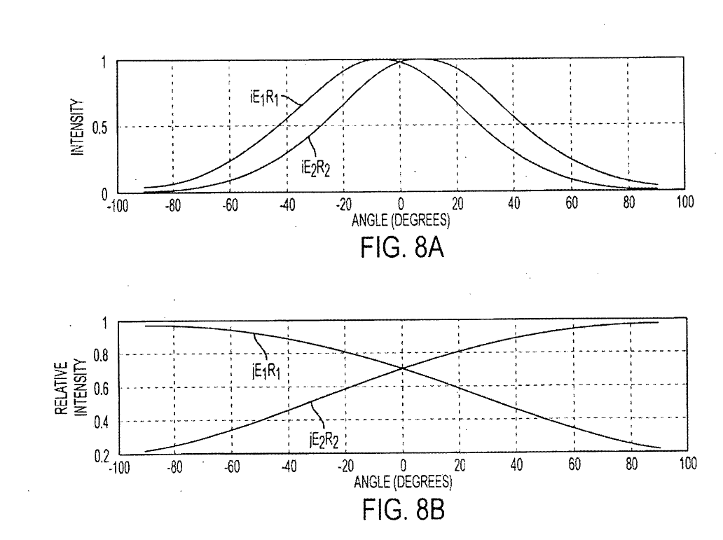

FIG. 8A shows the measured intensities i_{E1R1} and i_{E1R2} for receivers 42r1 and 42r2 as the receivers 42r1 and 42r2 are rotated from −90° to +90°. It is noted that in this particular example of FIG. 8A the angular separation of the two receivers is 15°, which is shown by the fact an angle difference between the maximum of i_{E1R1} and the maximum of i_{E1R2} is 15°. The maximum of i_{E1R1} corresponds to the case when the receivers 42r1 directly faces the emitter 42e and the maximum of i_{E1R2} corresponds to the case when the receivers 42r2 directly faces the emitter 42e.

The corresponding relative intensities j_{E1R1} and j_{E1R2} are shown in FIG. 8B. The relative intensity may be calculated as a ratio between an absolute (measured) intensity and a magnitude of the two intensities, i.e., j=i/M. In this particular example, j_{E1R1}=i_{E1R1}/M and j_{E1R2}=i_{E1R2}/M. The magnitude M may be calculated in one exemplary embodiment as the square root of the sum of the squares of each of the absolute intensities i_{E1R1} and i_{E1R2}:

M=\sqrt{i_{E1R1}²+i_{E1R2}²}

However, other definitions of the magnitude M may be used, as for example, the magnitude of one absolute intensity, the magnitude of the largest absolute intensity, etc. Also, if three emitters are used, the magnitude may include any combination of the three measured intensities.

Using the calculated relative intensity values, a function can be applied to determine the angle corresponding to these values. For example, with regard to FIG. 8B, by measuring that j_{E1R1} is 0.8 and j_{E1R2} is 0.6, the angle −17° is easily identified. For this particular example, the angle −17° indicates that the longitudinal axis A is pointed 17° away from the longitudinal axis B of the emitter. The sign of the determined angle indicates in which direction the emitter 42e points relative to axis A.

The function that converts the relative intensity values into an angle is denoted “h”. The function “h” may be implemented using any number of methods including a pure mathematical function, table lookup, or mathematical approximation. Function “h” is determined using the function “f” for each sensor. Each sensor may have a completely different response as long as that response is known and produces a function “h” that has an inverse for 0<φ≦90°.

Given the measured relative intensities and the known angularly dependent intensity gradient of the emitter's beam, the system (handheld device, base station or a combination of them) may compute the direction from the emitters to the receivers relative to the infrared emitters, i.e., the direction in the system of reference 20. In addition, the distance and direction of the array emitter relative to the array detector may be determined, i.e., the direction of the emitter relative to the system of reference 18. In this exemplary embodiment, it is assumed that the array emitter is located on or inside the base station and the array detector is located on or inside the handheld device. However, the array emitter may be configured to also be an array detector and vice versa.

Both the emitter and receiver arrays have their own spherical coordinates, (φ_{E}, θ_{E}) and (φ_{R}, θ_{R}), respectively, where label “E” is associated with emitter and label “R” is associated with receiver. Each sensor's (sensor is used herein as a generic term for both emitter and receiver) spherical coordinates are slightly offset from the array's spherical coordinates. As a result, each sensor measures a different intensity relative to any other sensor in the array. According to an exemplary embodiment, each receiver measures the intensity from each transmitter for a total of 9 independent measurements.

As previously discussed, the relative intensity strength between sensors is used to determine the position of the sensors relative to the base station. The relationship between measured intensities and relative intensities is similar to quadrature encoding or atan2.

Therefore, for a system having a single emitter (20) and three receivers (18), a function “h_{R}” can be determined such that:

J_{E1}=[j_{E1R1},j_{E1R2},j_{E1R3}] and

(φ_{R},θ_{R})=h_{R}(j_{E1R1},j_{E1R2},j_{E1R3})=h_{R}(J_{E1})

where (φ_{R},θ_{R}) define the direction of the emitter (20) relative to the receiver (18) and j_{E1R1}, j_{E1R2}, and j_{E1R3} are the relative intensities calculated based on the intensities measured by the three receivers for a same emitter.

Likewise, for a system having three emitters (20) and a single receiver (18), a function “h_{E}” can be determined such that:

J_{R1}=[j_{E1R1},j_{E2R1},j_{E3R1}] and

(φ_{E},θ_{E})=h_{E}(j_{E1R1},j_{E2R1},j_{E3R1})=h_{E}(J_{R1})

where (φ_{E}, θ_{E}) define the direction of the receiver (18) relative to the emitter (20) and j_{E1R1}, j_{E2R1}, and j_{E3R1} are the relative intensities calculated based on the intensities measured by the single receiver for the three emitters. The notation above use Ei to denote the emitter i, and Rj to denote the receiver j. Thus, j_{E2R1} is the measured relative intensity of emitter 2 as measured by receiver 1.

In still another application, having three emitters and three receivers, each receiver measuring intensities from each emitter, and knowing the relationships among the receivers of the array, the individual relations of the receivers versus detected relative intensities may be combined into an emitter gradient map defined by:

(φ_{E},θ_{E})=h_{E}(j_{E1R1},j_{E2R1},j_{E3R1})=h_{E}(J_{R1})

(φ_{E},θ_{E})=h_{E}(j_{E1R2},j_{E2R2},j_{E3R2})=h_{E}(J_{R2})

(φ_{E},θ_{E})=h_{E}(j_{E1R3},j_{E2R3},j_{E3R3})=h_{E}(J_{R3}).

Similarly, the equations may be used to create the receiver gradient map:

(φ_{R},θ_{R})=h_{R}(j_{E1R1},j_{E1R2},j_{E1R3})=h_{R}(J_{E1})

(φ_{R},θ_{R})=h_{R}(j_{E2R1},j_{E2R2},j_{E2R3})=h_{R}(J_{E2})

(φ_{R},θ_{R})=h_{R}(j_{E3R1},j_{E3R2},j_{E3R3})=h_{R}(J_{E3}).

As discussed previously, the functions h_{E} and h_{R} depend on the geometrical distribution of the emitters 42e and receivers 42r. According to an exemplary embodiment, for the calculation of both the (φ_{E}, θ_{E}) and (φ_{R}, θ_{R}) only the base station emits the radiation and not the handheld device. According to another exemplary embodiment, the receivers of the handheld device may be configured to emit the radiation and the emitters of the base station may be configured to receive the radiation and measure the intensities. According to another exemplary embodiment, one or more of the sensors (receivers and/or emitters) are configured to not emit/receive the same radiation intensity across all θ. As long as the angular gradient function h is well defined (i.e., three relative intensities map to one and only one pair of θ and φ for the sensor array), any emit/receive pattern may be used.

The above equations provide three separate estimates for each angle. The “best” estimate for each angle may be selected using any number of techniques, including averaging, weighted averaging, and weighted averaging based upon the corresponding value for ∥I∥. In addition, the best estimate could be computed using advanced combinatorial techniques that operate over time, such as Kalman filtering.

According to an exemplary embodiment, based on the angles (φ_{E}, θ_{E}, φ_{R}, θ_{R}) and the measured absolute intensities, the system may compute the distance d as discussed next. Each emitter produces an intensity defined by function g_{Ei} and the emitter angles (φ_{E1}, θ_{E1}) in the emitter reference frame. Each receiver measures an intensity defined by the function g and the receiver angles (φ_{R1}, θ_{R1}) it its reference frame. In an exemplary embodiment, if the infrared sensor is oriented in the direction (φ₁, θ₁) and the direction to the other sensor array is determined by (φ_{E}, θ_{E}), then the effective radiation angle φ_{E1} can be determine using the dot product:

φ_{E1}=cos⁻¹(cos(φ_{E})cos(φ₁)+cos(θ_{E}−θ₁)sin(φ_{E})sin(φ₁)).

The receiver angle can be computed similarly. Therefore, the expected measured radiation is given by:

i_{E1R1}=f_{R1}(φ_{R1},θ_{R1})f_{E1}(φ_{E1},θ_{E1})g_{E1}(d)

Thus, the distance d may be computed as:

d=g_{E1}⁻¹(i_{E1R1}/(f_{R1}(φ_{R1},θ_{R1})f_{E1}(φ_{E1},θ_{E1})))

In one application, each pair of emitter and receiver produces an estimate of distance d, for a total of 9 estimates in a three emitters and three receivers system. The actual distance estimate can be produced using any number of methods including averaging, weighted averaging based upon measured intensity, selection of the best measurement and Kalman filtering. According to an exemplary embodiment, a less accurate distance d may be calculated by neglecting one or more of angles φ_{R1}, φ_{E1}, θ_{R1}, and θ_{E1} thus relying, in one application, only on the absolute intensity i_{EiRj} of the measured beams.

The values φ_{E}, θ_{E}, and distance d provide a complete spherical coordinate definition of the location of the handheld device, i.e., the linear position of the handheld device relative to the base. These values may be converted into Cartesian coordinates or other coordinates as desired. In this application, a single receiver may be used. For optimal performance, the single receiver would ideally be omnidirectional and not have a response dependent upon φ_{R} or θ_{R}.

The values φ_{R}, θ_{R}, and distance d provide a complete spherical coordinate definition of the location of the base station device, i.e., the linear position of the base station relative to the handheld. These values may be converted into Cartesian coordinates or other coordinates as desired. In this application, a single emitter may be used. For optimal performance, the single emitter would ideally be omnidirectional and not have a response dependent upon φ_{E} or θ_{E}.

Next, the determination of Q_{R}, the angular position (orientation) of the handheld device, is discussed. The angular position of the handheld device relative to the base station may be defined by the following sequence of rotations: (1) Q_{E}, the arbitrary angular position of the base station relative to Earth's frame of reference; (2) Q_{E} around X; (3) φ_{E} around Y′; (4)ψ_{E}-ψ_{R} around X″; (5) −φ_{R} around Y′″; and (6) −θ_{R} around X″″, where Y′ means the new y axis after the system was rotated by θ_{T} around X, X″ means the new x axis after the system was rotated with φ_{T} around Y′, and so on.

Because ψ_{E} or ψ_{R} are not known, an accelerometer's measurement of gravity may be used to compute these angles, which will provide the full angular position of the handheld device. Without the accelerometer, the system knows the linear position of the handheld and the handheld's angular position in two out of three degrees of freedom. However, the accelerometer operates in Earth's frame of reference, not the base station frame of reference. Therefore, Q_{R} should be known to use the accelerometer to compute ψ_{T}-ψ_{R}. Once Q_{R} is known, the system can determine the handheld angular position relative to Earth's frame of reference, not just the base station's frame of reference. Q_{R} can either be measured using an accelerometer or calibrated (statically or dynamically) by measuring the values at multiple handheld positions.

As an example to calculate the angular position of the handheld device, the Euler angles are used to define rotation operators R_{X}(θ), R_{Y}(θ), and R_{Z}(θ). These operators perform a rotation around the axis specified by the subscript by an angle θ. For an Euler angle sequence of Z-Y-X, the resulting angular position is:

$${Q}_{B ← U} = {R}_{x} ( φ ) {R}_{y} ( θ ) {R}_{z} ( ψ )$$

Expanding the terms using a direction cosine matrix (DCM) representation for the rotation operation yields:

$$( \begin{matrix}1 & 0 & 0 \\ 0 & Cos [ φ ] & Sin [ φ ] \\ 0 & - Sin [ φ ] & Cos [ φ ]\end{matrix} ) \cdot ( \begin{matrix}Cos [ θ ] & 0 & - Sin [ θ ] \\ 0 & 1 & 0 \\ Sin [ θ ] & 0 & Cos [ θ ]\end{matrix} ) \cdot ( \begin{matrix}Cos [ ψ ] & Sin [ ψ ] & 0 \\ - Sin [ ψ ] & Cos [ ψ ] & 0 \\ 0 & 0 & 1\end{matrix} )$$

### Multiplying Through Yields

$$( \begin{matrix}Cos [ θ ] Cos [ ψ ] & Cos [ θ ] Sin [ ψ ] & - Sin [ θ ] \\ \begin{matrix}Cos [ ψ ] Sin [ θ ] Sin [ φ ] - \\ Cos [ φ ] Sin [ ψ ]\end{matrix} & \begin{matrix}Cos [ φ ] Cos [ ψ ] + \\ Sin [ θ ] Sin [ φ ] Sin [ ψ ]\end{matrix} & Cos [ θ ] Sin [ φ ] \\ \begin{matrix}Cos [ φ ] Cos [ ψ ] Sin [ θ ] + \\ Sin [ φ ] Sin [ ψ ]\end{matrix} & \begin{matrix}- Cos [ ψ ] Sin [ φ ] + \\ Cos [ φ ] Sin [ θ ] Sin [ ψ ]\end{matrix} & Cos [ θ ] Cos [ φ ]\end{matrix} )$$

The angular position of the base station from the Earth reference frame, Q_{E} can be given as an Euler angle sequence by:

Q_{E}=R_{X}(α_{E})R_{Y}(β_{E})R_{Z}(γ_{E})

The angular position of the handheld from the Earth frame, Q_{R}, can be given as an Euler angle sequence by:

Q_{R}=R_{X}(α_{R})R_{Y}(β_{R})R_{Z}(γ_{R})R_{Z}(γ_{E})

Q_{G} can be specified by the sequence of rotations using angles determined by the angular gradient system:

Q_{G}=R_{X}(−θ_{R})R_{Y}(−φ_{R})R_{X}(−ψ_{R})R_{X}(ψ_{E})R_{Y}(φ_{E})R_{X}(θ_{E}),

Combining these quantities together yields a rotation sequence equality

Q_{R}=Q_{G}Q_{E}.

When the accelerometer is stationary, it measures gravity:

$$g = ( \begin{matrix}0 \\ 0 \\ - g\end{matrix} )$$

The accelerometer also measures linear acceleration plus gravity in the handheld frame of reference. When the handheld is stationary, the accelerometer simply measures gravity:

$${g}_{M} = {Q}_{R} g = g ( \begin{matrix}sin ( {β}_{R} ) \\ - cos ( {β}_{R} ) sin ( {α}_{R} ) \\ - cos ( {β}_{R} ) cos ( {α}_{R} )\end{matrix} ) .$$

Due to the strength of gravity, the accelerometer effectively measures gravity even during small motions. Additional accuracy may be gained by low-pass filtering the accelerometer output or using additional sensors, such as angular velocity sensors, to improve the angular position estimate.

Using the gravity measurement, the angles α_{R} and β_{R} may be determined. Therefore, the unsolved variables are only γ_{E}, γ_{R} and ψ_{E}-ψ_{R}. However, the γ_{E} term cancels and ψ_{E}-ψ_{R} combines into a single variable ψ. Then only two variables are left in three equations, which are solvable under most conditions. Given data from different positions over time, it is possible to determine α_{E} and β_{E} if they are unknown. These angles could also be assumed to be zero, or an accelerometer could be included in the base station. Thus, the complete angular position of the handheld device may be calculated with the system discussed above.

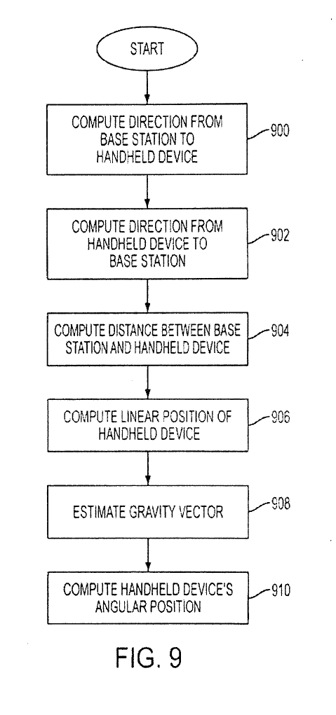

Next, the steps for calculating the position of the handheld device are discussed with regard to FIG. 9. In step 900, compute the direction from the base station to handheld device relative to the base station using the relative intensities discussed above. In step 902, compute the direction from the handheld device to the base station relative to the handheld device using the relative intensities. In step 904, compute the distance d between the base station and the handheld device using the measured intensities measured by the handheld device along with the known angles determined in steps 900 and 902. In step 906, combine data from steps 900 and 904 to compute the handheld device's linear position. In step 908, estimate the gravity vector relative to the handheld device using the accelerometer. In step 910, combine the data from steps 900, 902, and 908 to compute the handheld device's angular position.

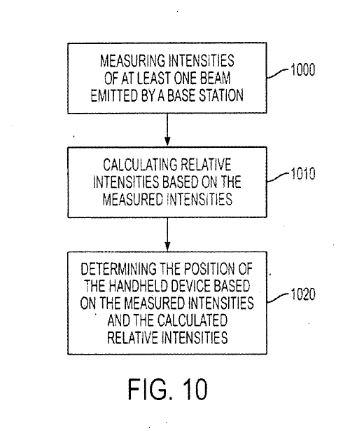

According to an exemplary embodiment, steps of a method for determining a position of the handheld device are illustrated in FIG. 10. The method includes a step 1000 of measuring intensities of at least one beam emitted by a base station, a step 1010 of calculating relative intensities based on the measured intensities, and a step 1020 of determining the position of the handheld device based on the measured intensities and the calculated relative intensities.

While the above exemplary embodiments have been discussed for an unpolarized wave, it would be recognized by those skilled in the art that the novel features may also be applied to polarized waves. An exemplary embodiment with four differently polarized emitters on a base station and four differently polarized receivers on the handheld could fully determine linear position and angular position without any additional sensors by extending “h” to include four inputs and produce three angular outputs. Also, the above embodiments have been discussed without using sensors positioned outside the handheld device. However, a system that may include sensors incorporated in the environment (for example, the walls of the room or on or in the TV set) may be configured to implement the above discussed novel features. Further, the above exemplary embodiments have been described to work without a camera. However, one skilled in the art would recognize that cameras may be implemented in the handheld device, the base station or both of them to improve the accuracy of the linear position and/or angular position.

According to another exemplary embodiment, there is a system that includes a handheld device having plural receivers, a base station having plural emitters and configured to communicate with the handheld device, and a processor connected to the plural receivers. The receivers are configured to measure intensities of beams emitted by the emitters, the processor is configured to calculate relative intensities based on the measured intensities, and the processor is configured to determine the position of the handheld device based on the measured intensities and the calculated relative intensities.

One skilled in the art would recognize that the above described exemplary embodiments may be modified, without departing from the scope of the invention, such that one handheld can be used on multiple base stations, multiple handhelds can be used with one base station, and multiple handhelds can be used with multiple base stations. For these cases, methods for differentiating emitters (different carrier frequencies, carrier frequency modulation, time division multiplexing) may be implemented so that each receiver is able to identify corresponding intensities. Further, one skilled in the art would recognize that the novel features described in the exemplary embodiments may be implemented in a system including any combination of N handheld devices and M base stations, with N and M being natural numbers. These systems would function similar to those devices already shown in the figures as long as intensities from emitters are measured at the receiver(s) and a processor is present in the system and configured to calculate relative intensities.

Further, it is possible to use the signal elements as both emitters and receivers. The N:M handheld to base station mappings described above may be resolved, according to exemplary embodiments, to 1:M, N:1, 1:1 mappings by providing feedback from one device to another indicating that the other device has been sensed. For example, depending on which TV a remote was pointing towards, that remote could dynamically control different TVs independently.

For an improved operation of the system, the base station angular position can be calibrated relative to gravity. End-user calibration (e.g., click at four corners, one each for two different roll values) is also possible. The infrared receiver amplifier circuits are low power and low cost. The above discussed embodiments describe an inexpensive structure, which is easily expandable to additional handhelds. The emitters and receivers discussed above may be easily obtained off the shelf, the angle measurements require relative (not absolute) intensity, the handheld device is small because there is no required spacing requirements between infrared components, the system works in dark or bright rooms, and the power used is low. To further reduce system cost, the sensors forming the sensor array may be combined into a single package.

Further, the novel embodiments described above track the position of a movable device relative to a base station. The accurately measured position of the handheld device may be communicated back to the host. Suitable hosts include PCs, TVs, TV set-top boxes, BlueRay players, interactive billboards, interactive whiteboards, projectors and other embedded computing platforms. The position measurements may be used as a human interface device for computers, television or any other display. The motion may be converted into onscreen pointer motion or even used directly to control or manipulate a virtual object.

Additional exemplary embodiments may include a system in which the infrared LEDs and infrared photodiodes may be swapped without altering the end device's performance. Also, if linear position is the only application requirement, then a solution with three infrared LEDs and one infrared photodiode (or one infrared LED and three infrared photodiodes) could be sufficient. For applications requiring extended precision, additional infrared LEDs or infrared photodiodes may be added. The measurement system described in this disclosure may be coupled with additional sensors, such as angular rate sensors, to produce an even higher precision output. The infrared photodiodes may be replaced by a camera (CCD) with a special lens. The RF receive signal strength indicator (RSSI) may be used to improve the distance measurement provided by the infrared intensity. The transmitted infrared signals may be modulated for increased isolation from environmental light. Also, the infrared signals may be time division multiplexed to reduce the infrared receiver circuit complexity. The infrared signals may be used to convey additional information, including the information indicated as sent over the RF link. By linearly separating the sensors in the emitter and receiver sensor arrays, the system may fully determine linear position and angular position without an accelerometer. The analysis above assumes that all sensors in a sensor array are located at the same point. By linearly separating the sensors, the angular gradient is no longer a simple angular gradient, but a function of both angle and linear position. The resulting system may then compute the position without need for an accelerometer. The possible disadvantage is increased error and noise susceptibility.

The disclosed exemplary embodiments provide a handheld device, a system, a method and a computer program product for detecting a position of the handheld device relative to a base station of the system. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a gaming console, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

The present exemplary embodiments may be implemented in a handheld device, a base station, and generally in a system including both the handheld device and the base station. The exemplary embodiments may also be implemented in an application specific integrated circuit (ASIC), or a digital signal processor. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. A processor in association with software may be used to implement a radio frequency transceiver for use in the user terminal, the base station or any host computer. The user terminal may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth module, a Zigbee module, an RF4CE module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

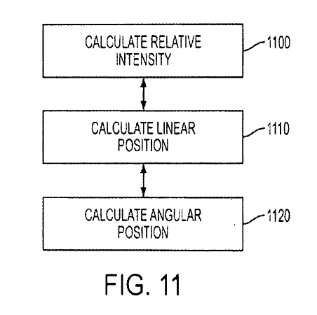

The general purpose processor may be configured to include the software modules shown in FIG. 11. More specifically, the general purpose processor may be programmed to calculate specific quantities, i.e., to be a specific processor. Example of the software modules are the relative intensity module 1100, the linear position module 1110, and the angular position module 1120. As the name of the software modules suggest, the relative intensity module 1100 calculates relative intensities j based on measured intensities i as discussed above. The linear position module 1110 calculates the linear position of the handheld device and the angular position module 1120 calculates the angular position of the handheld device.

According to an exemplary embodiment, the base station may include at least one emitter configured to emit a beam including an electromagnetic wave such that an intensity of the beam has a desired angular distribution in space and a processor configured to control an emitting time of the at least one emitter. The amplitude of the beam follows a same pattern in time at a given location. If the beam is not modulated, the amplitude is constant in time at the given location. In other words, the beam emitted by the emitters of the base station is not modulated in time. A system may include the base station and the handheld device and the system may be configured to calculate the position of the handheld device. Optionally, the system or one of its components may include a storing device for storing data and/or a display for displaying, for example, a position of the handheld device.

The linear position computed in 906 and the angular position computed in 910 may be used for numerous applications. For this paragraph, the position will be referred to as the output data. The output data may be used to produce a cursor on screen. The cursor location may be formed by a number of methods, including the intersection of the x forward direction of the device with the screen plane, angular velocity motion, orientation compensated angular velocity, or any method described in U.S. Provisional Patent Application No. 61/077,238, filed on Jul. 1, 2008, entitled “3D Pointer Mapping,” the content of which is incorporated in its entirety herein. The output data may be used to directly control a virtual object presented on screen, such as a sword, gun, pen, knife, flashlight and hands. The output data may be interpreted as gestures to issue commands to the host system. The output data may be used to drive a head-mounted display to overlay virtual images on the real world. The output data may be used to track a surgical instrument for medical applications.

Although the terms “handheld” and “base station” are used to describe the exemplary embodiment, the terms are flexible and intended to apply to the item being tracked and the reference to which the item is being tracked. For example, a robotic soccer implementation could define the goal as the base station and each robot as a handheld. As another example, the handheld could be a head-mounted device to perform full head tracking. In a construction application, the base station could be a building, and the handheld could be material, such as an I-beam, that is to be installed. Applications may utilize multiple handhelds working cooperatively, such as a full body tracking system.

The handheld may be extended to include switches, scroll wheels, joysticks, visible LEDs, speakers, a rumble motor, a rumble solenoid, capacitive touch sensing, an LCD display, a touch pad, and other features. The handheld may be connected to other devices. The handheld may not be self-contained, and need not be powered by batteries.

A handheld may not need to be permanently associated with a base station. The handheld may automatically detect the nearest base station and begin tracking relative to that base station. To facilitate making the correct RF connection, the base station could use its emitters to transmit a unique or semi-unique identification key. A handheld can detect the base station and look for the RF device with the same key. This allows the handheld to be carried to different base stations and work transparently to the user.

A single handheld may support multiple base stations simultaneously. The handheld could send output information to all stations that it detects. The signals from one base station could be received, processed and communicated without the knowledge of other base station. The modulation method of each base station would most likely need to be orthogonal to other base stations.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

What is claimed is:

1. A method for detecting a position of a handheld device, the method comprising:
measuring intensities of at least one beam emitted by a base station;
calculating relative intensities based on the measured intensities; and
determining the position of the handheld device based on the measured intensities and the calculated relative intensities.

2. The method of claim 1, further comprising:
providing that at least one beam have a predetermined angular gradient intensity distribution.

3. The method of claim 1, further comprising:
receiving intensities from plural base stations; and
independently controlling with the handheld device each base station of the plural base stations.

4. The method of claim 1, further comprising:
measuring the intensities with plural handheld devices; and
controlling the base station with each handheld device of the plural handheld devices.

5. The method of claim 1, further comprising:
determining a first direction from the base station to the handheld device based on the calculated relative intensities, the first direction being defined in a frame of reference associated with the base station; and
determining a second direction from the handheld device to the base station based on the calculated relative intensities, the second direction being defined in a frame of reference associated with the handheld device, wherein the first direction is defined by two angles and the second direction is defined by other two angles.

6. The method of claim 1, wherein the at least one beam is not modulated to transmit data.

7. The method of claim 2, wherein the step of determining the position further comprises:
calculating a distance from the handheld device to the base station based on the first direction, the second direction, and a distance function; and
determining a linear position of the handheld device as the distance of the handheld device from the base station along the first direction.

8. The method of claim 4, further comprising:
storing a lookup table that maps the measured intensities to the two angles and/or to the two other angles defining the first and second directions, and/or
storing a lookup table mapping the two angles defining the first direction, the other two angles defining the second direction and measured intensities to the distance between the handheld device and the base station.

9. The method of claim 1, further comprising:
measuring three intensities of the at least one beam with three different receivers provided on the handheld device.

10. The method of claim 1, further comprising:
emitting three different beams from the base station.

11. The method of claim 10, further comprising:
modulating differently the three different beams.

12. The method of claim 5, further comprising:
determining a two angles angular position of the handheld device based on the determined first direction and the determined second direction.

13. The method of claim 12, further comprising:
estimating a gravity vector; and
computing a third angle of the angular position of the handheld device relative to the base station based on the gravity vector.

14. The method of claim 1, further comprising:
associating a cursor on a screen with the handheld device position.

15. A handheld device for detecting a position relative to a base station with which the handheld device communicates, the handheld device comprising:
a first receiver configured to measure intensities of beams emitted by a base station; and
a processor connected to the first receiver and configured to,
calculate relative intensities based on the measured intensities, and
determine the position of the handheld device based on the measured intensities and the calculated relative intensities.

16. The handheld device of claim 15, wherein the processor is further configured to determine a first direction from the base station to the handheld device based on the calculated relative intensities, the first direction being defined in a frame of reference associated with the base station.

17. The handheld device of claim 16, further comprising:
second and third receivers configured to measure the intensities,
wherein the processor is further configured to determine a second direction from the handheld device to the base station based on the calculated relative intensities, the second direction being defined in a frame of reference associated with the handheld device, wherein the first direction is defined by two angles and the second direction is defined by other two angles.

18. The handheld device of claim 17, further comprising:
a storing device configured to store a lookup table that maps the measured intensities to the two angles and/or to the two other angles defining the first and second directions.

19. The handheld device of claim 17, wherein the processor is further configured to:
calculate a distance from the handheld device to the base station based on the first direction, the second direction, and a distance function; and
determine a linear position of the handheld device as the distance of the handheld device from the base station along the first direction.

20. The handheld device of claim 19, further comprising:
a storing device configured to store a lookup table mapping angles defining the first direction, angles defining the second direction and measured intensities to the distance between the handheld device and the base station.

21. The handheld device of claim 17, wherein the processor is further configured to determine a two angles angular position of the handheld device based on the determined first direction and the determined second direction.

22. The handheld device of claim 21, further comprising:
an accelerometer configured to estimate a gravity vector,
wherein the processor is further configured to compute a third angle of the angular position of the handheld device relative to the base station based on the gravity vector.

23. A base station configured to communicate with a handheld device, the base station comprising:
at least one emitter configured to emit a beam of an electromagnetic wave such that an intensity of the beam has a desired angular distribution in space; and
a processor configured to control an emitting time of the at least one emitter, wherein an amplitude the beam follows a same pattern in time at a given location.

24. The base station of claim 23, wherein the beam is not modulated.

25. The base station of claim 23, wherein the processor is further configured to receive data from the handheld device, the data being indicative of a first direction from the base station to the handheld device and a second direction from the handheld device to the base station.

26. The base station of claim 23, wherein the processor is further configured to compute a distance from the handheld device to the base station based on the received data from the handheld device.

27. The base station of claim 23, wherein the processor is further configured to compute a linear position of the handheld device and an angular orientation of the handheld device based on the received data from the handheld device.

28. The base station of claim 23, further comprising:
second and third sensors configured to be displaced with the at least one sensor on a spherical, equilateral triangle.

29. A system comprising:
a handheld device having a first receiver;
a base station having plural emitters and configured to communicate with the handheld device; and
a processor configured to communicate with the first receiver, wherein
the first receiver is configured to measure intensities of beams emitted by the emitters,
the processor is configured to calculate relative intensities based on the measured intensities, and
the processor is configured to determine the position of the handheld device based on the measured intensities and the calculated relative intensities.

30. The system of claim 29, wherein each of the plural emitters is configured to emit a corresponding beam having a predetermined angular gradient intensity distribution.

31. The system of claim 29, further comprising:
plural base stations configured to communicate with the handheld device,
wherein the handheld device is configured to independently control each base station of the plural base stations.

32. The system of claim 29, further comprising:
plural handheld devices configured to communicate with the base station,
wherein each handheld device of the plural handheld devices is configured to independently control the base station.

33. The system of claim 29, wherein the processor is distributed only at the base station or only at the handheld device.

34. The system of claim 29, wherein the processor is configured to,
determine a first direction from the base station to the handheld device based on the calculated relative intensities, the first direction being defined in a frame of reference associated with the base station; and
determine a second direction from the handheld device to the base station based on the calculated relative intensities, the second direction being defined in a frame of reference associated with the handheld device, wherein the first direction is defined by two angles and the second direction is defined by other two angles.

35. The system of claim 34, wherein the processor is further configured to:
calculate a distance from the handheld device to the base station based on the first direction, the second direction, and a distance function; and
determine a linear position of the handheld device as the distance of the handheld device from the base station along the first direction.

36. The system of claim 34, wherein the processor is further configured to:
determine a two angles angular position of the handheld device based on the determined first direction and the determined second direction.

37. The system of claim 36, wherein the processor is further configured to:
estimate a gravity vector; and
compute a third angle of the angular position of the handheld device relative to the base station based on the gravity vector.

38. A computer readable medium including computer executable instructions, wherein the instructions, when executed, implement a method for detecting a position of a handheld device, the method comprising:
providing a system comprising distinct software modules, wherein the distinct software modules comprise a relative intensity calculation module, a linear position calculation module and an angular position calculation module;
measuring intensities of at least one beam emitted by a base station;
calculating, based on the relative intensity calculation module, relative intensities based on the measured intensities; and
determining, based on the linear position calculation module, the position of the handheld device based on the measured intensities and the calculated relative intensities.

39. The medium of claim 36, further comprising:
determining a first direction from the base station to the handheld device based on the calculated relative intensities, the first direction being defined in a frame of reference associated with the base station; and
determining a second direction from the handheld device to the base station based on the calculated relative intensities, the second direction being defined in a frame of reference associated with the handheld device, wherein the first direction is defined by two angles and the second direction is defined by other two angles.

40. The medium of claim 39, wherein the at least one beam is not modulated to transmit data.

41. The medium of claim 39, wherein the step of determining the position further comprises:
calculating a distance from the handheld device to the base station based on the first direction, the second direction, and a distance function; and
determining a linear position of the handheld device as the distance of the handheld device from the base station along the first direction.

42. The medium of claim 41, further comprising:
storing a lookup table that maps the measured intensities to the two angles and/or to the two other angles defining the first and second directions, and/or
storing a lookup table mapping the two angles defining the first direction, the other two angles defining the second direction and measured intensities to the distance between the handheld device and the base station.

43. The medium of claim 38, further comprising:
measuring three intensities of the at least one beam with three different receivers provided on the handheld device.

44. The medium of claim 38, further comprising:
emitting three different beams from the base station.

45. The medium of claim 43, further comprising:
modulating differently the three different beams.

46. The medium of claim 39, further comprising:
determining a two angles angular position of the handheld device based on the determined first direction and the determined second direction.

47. The medium of claim 46, further comprising:
estimating a gravity vector; and
computing a third angle of the angular position of the handheld device relative to the base station based on the gravity vector.
